(19) United States
(12) Patent Application Publication
(10) Pub. No.: US 2010/0121016 A1
(43) Pub. Date: May 13, 2010

(54) LOW REFRACTIVE INDEX HYBRID OPTICAL CLADDING AND ELECTRO-OPTIC DEVICES MADE THEREFROM

(75) Inventors: Danliang Jin, Bothell, WA (US); Guomin Yu, Bothell, WA (US); Hui Chen, Kirkland, WA (US)

Correspondence Address: GRAYBEAL JACKSON LLP, 400 - 108TH AVENUE NE, SUITE 700, BELLEVUE, WA, 98004, US

(73) Assignee: GIGOPTIX, INC., Bothell, WA (US)

(21) Appl. No.: 12/559,690

(22) Filed: Sep. 15, 2009

Related U.S. Application Data
(60) Provisional application No. 61/097,166, filed on Sep. 15, 2008.
(60) Provisional application No. 61/097,172, filed on Sep. 15, 2008.

(51) Int. Cl. C08G 77/24

(52) U.S. Cl. 528/30

(57) ABSTRACT

A low index of refraction hybrid optical cladding may be formed from a fluorinated sol-gel. An electro-optic device may include a poled organic chromophore-loaded modulation layer and at least one adjacent fluorinated hybrid sol-gel clad.

### CROSS-REFERENCE TO RELATED APPLICATIONS

This application claims priority benefit under 35 U.S.C. §119(e) from, and to the extent not inconsistent with this application, incorporates by reference herein U.S. Provisional Patent Application Ser. No. 61/097,166; filed Sep. 15, 2008; entitled “LOW REFRACTIVE INDEX HYBRID OPTICAL CLADDING AND ELECTRO-OPTIC DEVICES MADE THEREFROM”; invented by Danliang Jin, Guomin Yu, and Hui Chen.

This application is also related to U.S. Provisional Patent Application Ser. No. 61/097,172 (attorney docket number 2652-022-02); filed Sep. 15, 2008; entitled “ELECTRO-OPTIC DEVICE AND METHOD FOR MAKING LOW RESISTIVITY HYBRID POLYMER CLADS FOR AN ELECTRO-OPTIC DEVICE”; invented by Danliang Jin, Guomin Yu, Anna Barklund, Hui Chen and Raluca Dinu; and to the extent not inconsistent.

### STATEMENT REGARDING FEDERALLY SPONSORED RESEARCH OR DEVELOPMENT

The inventions disclosed herein were made the U.S. Government support pursuant to NRO Contract No. NRO000-07-C-0123 and DARPA Contract No. W31P4Q-08-C-0198. Accordingly, the Government may have certain rights in the inventions disclosed herein.

### BACKGROUND

Electro-optic devices, and especially poled hyperpolarizable organic chromophore-based electro-optic devices have typically been limited to using hybrid organic-inorganic cladding materials that have a relatively high index of refraction. For example, a crosslinked hybrid organic-inorganic silicon sol-gel may have an index of refraction of 1.45 to 1.47 at a wavelength of 1550 nanometers (nm). Other crosslinked hybrid organic-inorganic sol-gels made from titanate, aluminate, or zirconate precursors have also typically had respective indices of refraction that are substantially determined according to the particular type of sol-gel (i.e. titanium, zirconium, or aluminum-based).

### SUMMARY

According to embodiments, a hybrid organic-inorganic cladding may be made including at least one precursor having a covalently bound fluorinated organic group. The fluorinated group may reduce the index of refraction of the cladding.

According to embodiments, a silicon sol-gel cladding may include covalently bound fluorinated groups that reduce the index of refraction of the cladding to below 1.45. According to embodiments, the index of refraction may be between about 1.35 and 1.44.

According to embodiments, an electro-optic device may include a hybrid organic-inorganic cladding may be made including at least one precursor having a covalently bound fluorinated organic group. The fluorinated group may reduce the index of refraction of the cladding.

According to embodiments, an electro-optic device may include silicon sol-gel cladding having covalently bound fluorinated groups that reduce the index of refraction of the cladding to below 1.45. According to embodiments, the index of refraction may be between about 1.35 and 1.44. The electro-optic device may include an electro-optic core having poled chromophores in a polymer matrix. The polymer matrix of the core may also include silicon sol-gel cladding having covalently bound fluorinated groups.

### BRIEF DESCRIPTION OF THE FIGURES

FIG. 1 is a cross-sectional diagram of an electro-optic device, according to an embodiment.

FIG. 2 is a simplified diagram of system including an electro-optic device of FIG. 1, according to an embodiment.

FIG. 3 a flow chart showing a method for making a hybrid organic-inorganic optical cladding according to an embodiment.

FIG. 4 is a cross-sectional diagram of an alternative device structure, according to an embodiment.

FIG. 5 is a cross-sectional diagram of another alternative device structure, according to an embodiment.

FIG. 6 is a diagram illustrating a device at several steps of fabrication, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or and other changes may be made without departing from the spirit or scope of the disclosure.

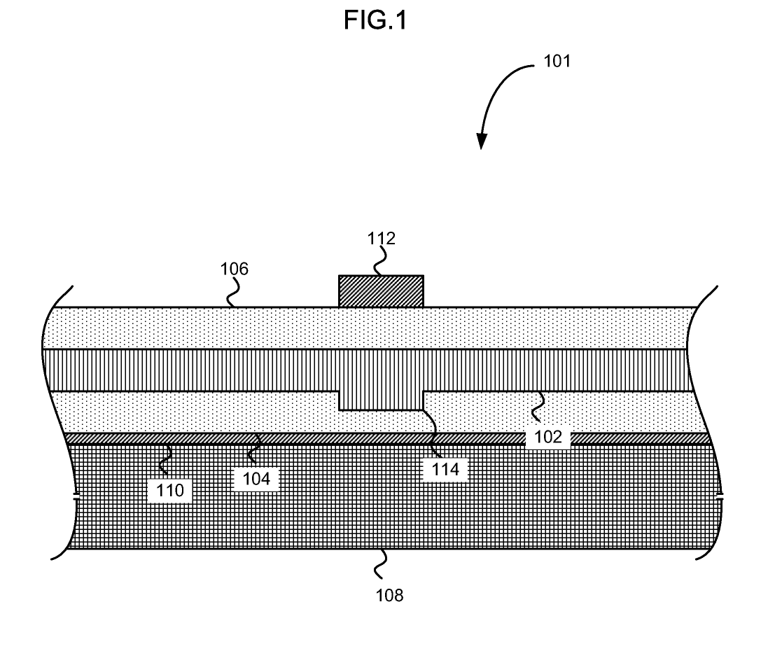

FIG. 1 is a cross-sectional diagram of an electro-optic device 101, according to an embodiment. The electro-optic device 101 includes an electro-optic core 102 disposed between optical clads 104 and 106. The electro-optic device 101 may be formed over a substrate 108 such as silicon, silicon-on-insulator, glass, or other semiconducting or insulating wafer. Two electrodes 110, 112 are arranged to apply a modulation voltage across the electro-optic core 102 through the clads 104, 106. One or more light guiding structures 114, such as a trench waveguide, etc. may be provided to guide light transmitted through the electro-optic core 102 for modulation.

The electro-optic core may include at least one type of hyperpolarizable organic chromophore and cross-linked polymer. The at least one hyperpolarizable organic chromophore and the polymer may form a guest-host material. Alternatively, the hyperpolarizable organic chromophore may be covalently bonded to the cross-linked polymer, or may be otherwise held in the cross-linked polymer. The cross-linked polymer may include an organic polymer, such as amorphous polycarbonate for example, or may include a hybrid material such as a sol-gel.

Typically, the electro-optic core material is poled, ideally to substantially align the chromophores. The core may be poled by applying a poling voltage from a poling electrode (not shown in FIG. 1) across the electro-optic core 102 through some or all of the cladding 106, 104 thickness while the device 101 is heated to near a glass transition temperature, Tg, of the polymer in the core. After the chromophores are aligned, the device 101 is cooled to “lock” the chromophores into their poled orientations. The poling electrode 116 may include a temporary electrode that is removed after poling. Alternatively, a modulation electrode 112 may be used as a poling electrode 116.

According to embodiments, the optical index of refraction or refractive index of the material in at least one of the optical clads 104, 106 is lower than the index of refraction of previous polymer cladding materials and especially of previous hybrid organic-inorganic polymer cladding materials, such as organic-inogranic sol-gels hybrids, which may typically have an index of refraction of 1.45 to 1.47 at 1550 nm. For example, the optical clads 104, 106 may have indices of refraction of about 1.35 or lower to just below the 1.45 to 1.47 index of previous materials. According to another embodiment, the optical clads 104, 106 may have indices of refraction between 1.39 or lower to just below 1.45. According to another embodiment, the optical clads 104, 106 may have indices of refraction of between 1.391 and 1.404.

The reduced index of refraction may be used to increase index contrast between the electro-optic core 102 and one or both of the clads 104, 106. Alternatively or additionally, the reduced index of refraction at least one clad 104, 106 may allow modifications to the electro-optic core 102, such as to decrease the index of refraction of the electro-optic core 102, increase the size of the electro-optic core 102 while maintaining numerical aperture, etc.

According to other embodiments, fluorinated organically modified sol-gel precursors of silica, titania, zirconia, and/or alumina may combined with non-fluorinated organically modified sol-gel precursors of silica, titania, zirconia, and/or alumina along with hydrolysable precursors of silica, titania, zirconia, and/or alumina to produce a hybrid sol-gel optical cladding having a selected index of refraction.

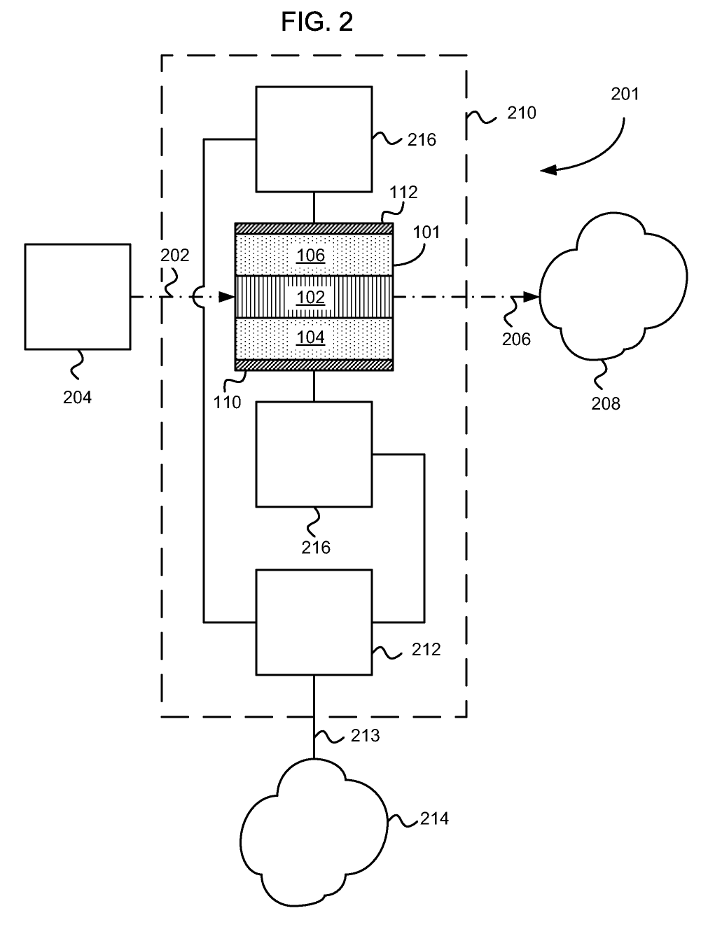

FIG. 2 is a simplified diagram of system 201 including an electro-optic device 101, according to an embodiment. In operation, light 202 such as laser light from a laser 204 at an infrared wavelength may be passed through the electro-optic core 102. To provide light guidance and minimize optical losses, the optical clads 104, 106 typically have indices of refraction that are lower than the index of refraction of the electro-optic core 102. For example, according to an embodiment, the nominal index of refraction of the electro-optic core 102 may be about 1.5 to 1.8 and the index of refraction of the clads 104, 106 may be less than 1.45 to 1.47. According to another embodiment, the nominal index of refraction of the electro-optic core 102 may be less than about 1.5-1.8 and the index of refraction of the clads 104, 106 may be less than about 1.45-1.47. According to another embodiment, the index of refraction of the clads 104, 106 may be about 1.35 to about 1.4.

During operation, one electrode 110 may be held at ground while the other electrode 112 is voltage modulated. In some applications, the electrode 112 may be a top electrode that is provided in the form of a high speed strip electrode configured to propagate modulation pulses along its length, parallel to and preferably at least somewhat velocity-matched to the propagation of light through the electro-optic core 102. The poled hyperpolarizable chromophore in the electro-optic core 102 responds to the modulation voltage with a corresponding change in refractive index, which operates to modulate the phase of the propagated light 202. A device may be used to provide a phase-modulated light signal 206 for transmission through a network 208. Alternatively, a device, such as in a Mach-Zehnder modulator, may include plural optical channels, each modulating a portion of coherent light, which when the light is rejoined, may destructively or constructively interfere to provide an amplitude-modulated light signal 206 for transmission.

According to embodiments, the electro-optic device 101 may be combined with other components in an integrated device 210. Such components may include a receiving circuit 212 configured to receive one or more signals along an input signal transmission path 213 from a network 214 or other signal source, and drive electronics 216 configured to provide the drive signal to the electrodes 110, 112.

According to embodiments, the bottom clad 104 may be about 1-2 microns thick below the waveguide 114 and/or about 2-2.4 microns thick without the trench waveguide 114 or at locations not corresponding to a trench waveguide 114. The electro-optic core 102 may be about 3 microns thick including a trench waveguide 114 and/or about 2 microns thick without the trench waveguide 114 or at locations not corresponding to the trench waveguide 114. The top clad may be about 0.5 to 2.0 microns thick.

Referring again to FIG. 1, the low index of refraction material in the cladding layers 104, 106 includes a hybrid organic-inorganic material. The hybrid organic-inorganic material may be referred to as a sol-gel material. The chemical structure of the sol-gel may be expressed as:

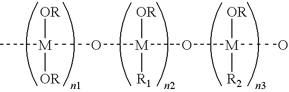

where M is Si, Ti, Al, or Zr;
R is a hydrolizable group;
R₁ is an organic crosslinker;
R₂ is a fluorinated organic group or fluorine; and
n1, n2, and n3 may be modified to provide selected mechanical, electrical, and/or optical properties.

The actual physical structure of a cured clad 104, 106 is typically a three-dimensional matrix of M's linked in an amorphous gel by a combination of M-O-M and M-R₁-M linkages with pendent (unlinked) R (e.g., a trace amount), R₁, and R₂ groups. This may be depicted as:

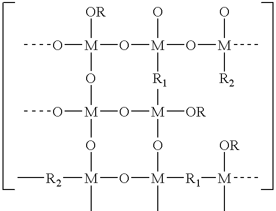

RO— may be a hydrolysable alkoxy group such as —OCH₃ or —OCH₂ CH₃, or in hydrolyzed form, —OH. The M-O— backbone may link or gel to form silicate, titanate, aluminate, or zirconate (M-O-M) bonds through displacement of the hydrolysable groups (e.g. after being fully condensed).

R₁ is a reactive organic crosslinker such as an epoxy:

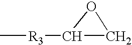

(e.g. glycidyl propyl ether), or an acrylate:

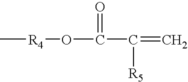

where R₃, R₄, and R₅ are alkyl or aromatic groups.

The organic crosslinker R₁ may link the M backbone through an organic (M-R₁-M) linkage. Thus, the sol-gel includes both -M-O-M- and -M-R₁-M- linkages. The M-O-M linkage is a very reactive linkage with large number density that may tend to make the material brittle. The inclusion of M-R₁-M linkages may significantly improve the toughness of the material and makes it more processible and suitable for use as an optical cladding.

R₂ is a fluorinated organic group or fluorine that is pendent on the M backbone. For example, R₂ may be a partially or substantially fully fluorinated alkyl or aryl group. According to embodiments, R₂ may include fluorine, —F; a perfluorododecyl-1H,1H,2H,2H-triethyl group, —CH₂—CH₂—CF₂—CF₂—CF₂—CF₂—CF₂—CF₂—CF₂—CF₂—CF₂—CF₃; a perfluorotetradecyl-H,1H,2H,2H-triethyl group, —CH₂—CH₂—CF₂—CF₂—CF₂—CF₂—CF₂—CF₃; a pentafluorobenzyl group,

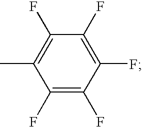

or other fluorinated and relatively non-reactive group. The fluorinated group R₂ tends to reduce the index of refraction of the organic-inorganic hybrid clads. Generally, a larger proportion of fluorinated groups within the hybrid materials composition may provide a greater reduction in index of refraction. The fluorinated groups R₂ listed above are selected based on their relatively wide commercial availability. Other fluorinated groups may be substituted as desired.

The stoichiometery of the groups

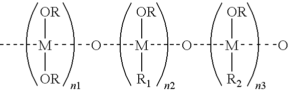

may be varied according to device design considerations, cost, etc. For example, larger values of n1 may tend to make the cladding 104, 106 relatively hard but also relatively brittle. Larger values of n2 may tend to make the cladding 104, 106 tougher. Larger values of n3 tend to reduce the index of refraction. According to one embodiment where M was 100% Si, R₂ was —(CH₂)₂(CF₂)₅CF₃, and n1=2, n2=1, and n3=1; an optical cladding 104, 106 was produced having an index of refraction of 1.397 at 1550 nm. A comparison of two compositions, LIP1 and LIP2 with differing n1, n2, and n3 values is presented in the table below:

| | | | tridecafluoro- | |
|---|---|---|---|---|
| | | 3- | tetrahydro- | |
| | | glycidoxypropyl- | octyltrieth- | |
| | Tetraethoxysilane | trimethoxysilane | oxysilane | Index at |
| | (mole) | (mole) | (mole) | 1550 nm |
| LIP1 | 0.48 | 0.12 | 0.24 | 1.3940 |
| LIP2 | 0.20 | 0.10 | 0.20 | 1.4040 |

For low index of refraction optical clads 104, 106, M=Si provides the lowest starting index of the group Si, Ti, Al, Zr, and may thus provide the lowest index of refraction. Fluorinated groups R₂ may alternatively be added to non-silicon sol-gels or partially non-silicon sol-gels to tune the index of refraction and/or to tune the dielectric constant. Adding fluorinated groups R₂ may generally decrease the dielectric constant of the optical cladding 104, 106. Sol-gels produced from combinations of M's, for example Si and Ti, may be used to provide indices of refraction between the two materials when used alone.

For example a cladding 104, 106 with the formula:

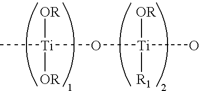

(with no fluorinated groups R₂) may have an index of refraction of about 1.8, while a cladding 104, 106 with the formula:

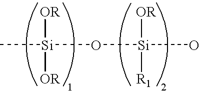

(also with no fluorinated groups R₂) may have an index of refraction of about 1.45 to 1.47. Mixing titania and silica precursers to form a hybrid sol-gel having the formula:

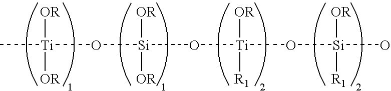

(with no fluorinated groups R₂) may provide an approximate index of refraction equal to the average of the Ti- and Si-based sol-gels: ((1.45)+(1.8))/2=1.625. Similarly, combining titania and silica precursors in different ratios will generally produce a weighted average of the individual indices of refraction.

Adding fluorinated groups decreases the index of refraction further, and may allow the designer an extra degree of freedom with respect to the properties of the cladding 104, 106.

To reduce the electrical resistivity, the hybrid organic-inorganic cladding material may be doped with an inorganic or organic salt. The concentration of the salt may be at a concentration equal to or less than about 5%, for example. According to an embodiment, the cladding is doped with an inorganic salt of lithium, sodium, or potassium at a concentration equal to or less than about 2%. According to an embodiment, the cladding is doped with lithium perchlorate at a concentration of between about 1% and 3%. According to an embodiment, the cladding may be doped with lithium perchlorate at a concentration of about 2%.

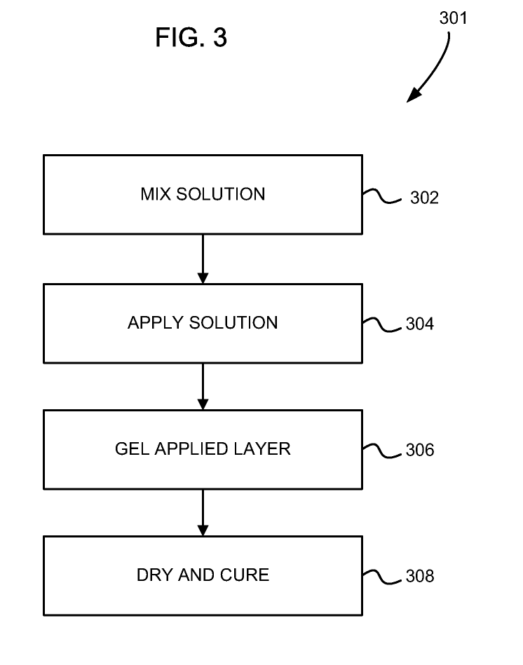

FIG. 3 is a flow chart showing a method 301 for making a hybrid organic-inorganic optical cladding according to an embodiment. In step 302, a sol-gel solution including a sol-gel precursor for silica :

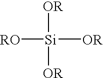

and organically modified silica precursors:

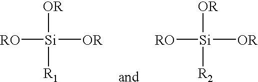

is mixed in solution. As described above,
R is a hydrolizable group;
R₁ is an organic crosslinker; and
R₂ is a fluorinated organic group or fluorine.

According to embodiments, the silica precursor and organically-modified silica precursors may be mixed in a solution at a wide range of molar ratios. For example, embodiments of low index sol-gels whose indices of refraction are disclosed in this application include molar ratios of about 2:1:1, 2:1:2, and 4:1:2 silica precursor:cross-linker modified precursor:fluorination modified precursor.

Specific embodiments may be made by reference to the following examples:

Example 1 (LIP3):
1. To a 1 liter round bottom flask, 49.92 gram (0.24 mol) of, 56.76 gram (0.24 mol) of 3-glycidoxypropyltrimethoxysilane, 91.87 gram (0.18 mol) of tridecafluoro-tetrahydrooctyltriethoxysilane, and 179 gram of ethanol were charged with magnetic stirring.
2. Mixed 50.88 gram of H₂O and 9.8 gram of 2M HCl.
3. Slowly dropped the acid into the round bottom flask and stirred until the solution became clear.
4. The flask was equipped with condenser and purged with nitrogen and immersed in a 60° C. oil bath. The solution was maintained refluxing for four hours. The solution was then cooled to room temperature.
5. 1.60 gram of aluminum acetylacetonate was added into the solution while stirring. The solid dissolved slowly and a clear solution was obtained.
6. The solution was aged overnight. The solution was then ready for thin film deposition.

Example 2 (LPT1):

Preparation of a Fluorinated Sol-Gel:
A fluorinated sol-gel was prepared by adding 99.96 g (0.48 mol) of tetraethoxysilane, 236.3 g (0.12 mol) of 3-glycidoxypropyltrimethoxysilane, 122.40 g (0.24 mol) of tridecafluorotetrahydrooctyltriethoxysilane, and 312 g of isopropyl alcohol to a 1 L round bottom flask. The resulting mixture was stirred and a solution of 4.32 g of 2M DCI in 60 g of D₂O was added dropwise slowly until the mixture became clear. The resulting solution was refluxed for 3 h then allowed to cool to room temperature overnight. The isopropyl alcohol and other volatile reaction products were removed under reduced pressure. The resulting solution was diluted with 200 g of n-butanol, 40 g of cyclopentanone, and stored in 0° C. refrigerator.

Proceeding to step 304, the solution is applied to a surface. For example, the solution may be spin-coated or sprayed onto a substrate such as a silicon, glass, or silicon-on-insulator wafer. The substrate may include one or a plurality of bottom electrodes (FIG. 1, 110).
For example, following steps 1-6 from Example 1, above:
7. The solution was spin-coated onto a silicon wafer having a plated or sputtered gold conductor at 1000 rpm and cured on a hot plate at 150 C for 1 hr. The film thickness was 2.0-2.2 mm. The refractive index was about 1.397 at a wavelength of 1550 nm.

Next, in step 306, the applied layer is cured thermally or via an ultraviolet and thermal process. A backbone molecular structure for the cured material may be expressed as:

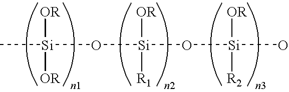

where:
—OR is a hydrolizable group such as —OCH₂CH₃;
R₁ is an organic crosslinker such as:

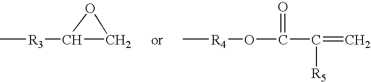

R₂ is a fluorinated organic group, such as:

—(CH₂)₂(CF₂)₅CF₃;

where R₃, R₄, and R₅ are alkyl or aromatic groups;
n1=2;
n2=1; and
n3=1.

There are two types of gelling or crosslinking mechanisms. One is from the inorganic backbone ( . . . Si—O—Si . . . ) and the other is from the organic crosslinker ( . . . Si—R₁—Si . . . ). The combination of crosslink types provides for the excellent mechanical and optical properties provided by the hybrid sol-gel clads.

Proceeding to step 308, the gelled material is further condensed and cured to form a solid film, which in turn forms the optical cladding. For example the film may be cured by placing the substrate on a hot plate at 150° C. for 1 hr.

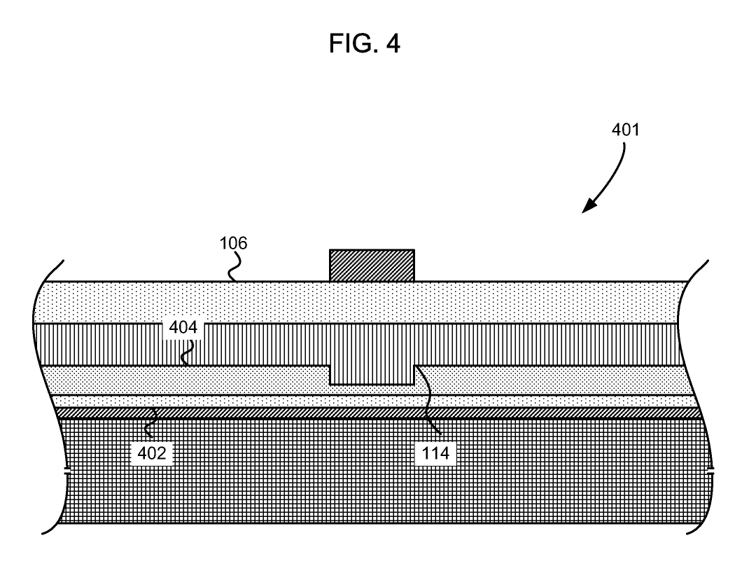

FIG. 4 is a cross-sectional diagram of an alternative device structure 401, according to an embodiment. In some embodiments, it may be advantageous to combine the low index of refraction hybrid organic-inorganic cladding layers with one or more other cladding layers formed from more conventional materials. For example, a bottom cladding layer may include a first cladding layer 402 made with a low index of refraction hybrid organic-inorganic material described herein. The bottom cladding may also include another cladding layer 404. For example, the additional cladding layer 404 may include a higher index of refraction material such as a UV-cured polymer, a cross-linked polymer, a non-fluorinated sol-gel, or another conventional cladding material. The upper cladding layer 106 may be formed from a low index of refraction hybrid organic-inorganic material as described above, or may be made of an alternative material such as a UV-cured polymer, a cross-linked polymer, a non-fluorinated sol-gel, or another conventional cladding material.

One attribute of the device structure may be that the etching process used to form the waveguide structure 114 may be performed on an alternative material. Etching an alternative material may be advantageous in some embodiments for process considerations.

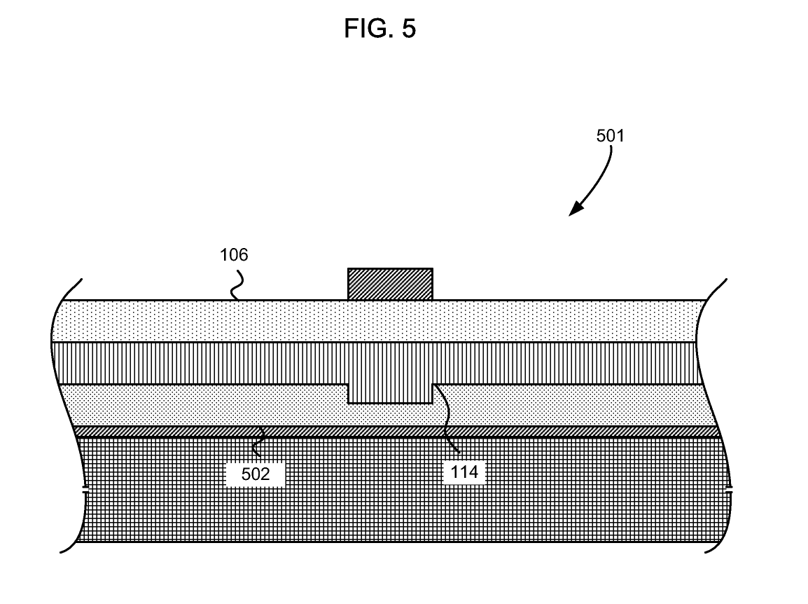

FIG. 5 is a cross-sectional diagram of another alternative device structure 501, according to an embodiment. In the embodiment of FIG. 5, the bottom low index of refraction hybrid organic-inorganic cladding layer 104 is substituted with another type of cladding 502. The device 501 uses a bottom clad 502 with dry-etched trench waveguide 114 formed from UV15LV, a conventional ultraviolet-cured cross-linked polymer. The top-cladding 106 is formed from a low index of refraction hybrid organic-inorganic material taught herein.

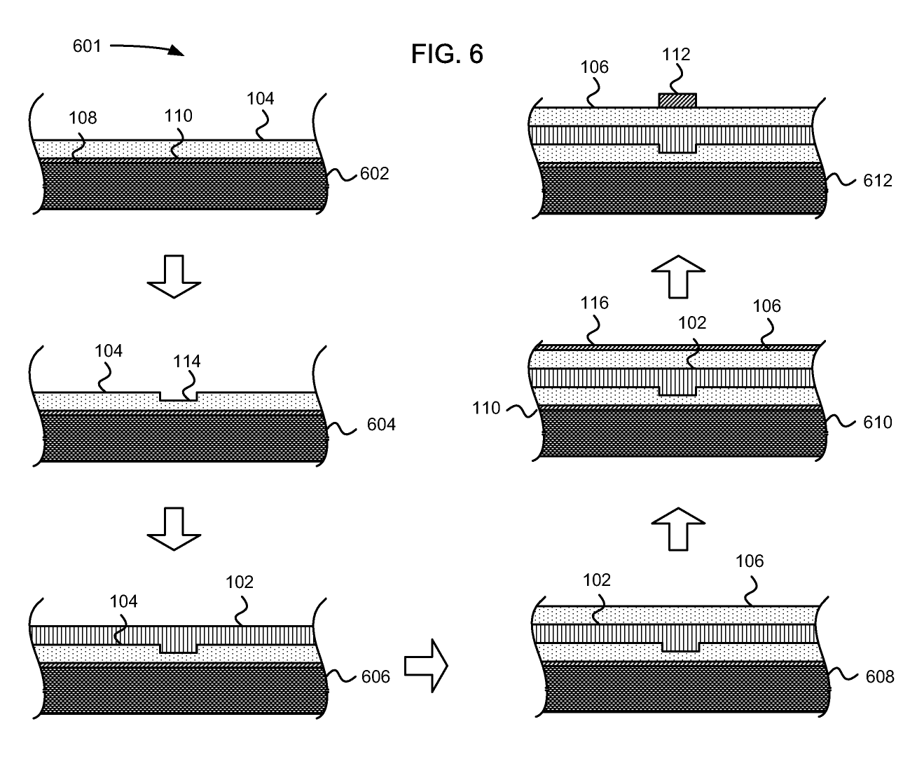

FIG. 6 is a diagram 601 illustrating a device 101 at several steps of fabrication 602 to 612, according to an embodiment. First, as shown at step 602, a bottom cladding layer 104 is deposited over a substrate 108 and bottom electrode 110. The bottom cladding layer may be a low index of refraction hybrid organic-inorganic material as described elsewhere herein. Alternatively, a bottom cladding layer may be formed as a composite with a first cladding layer (see 402 in FIG. 4) made with a low index of refraction hybrid organic-inorganic material described herein and another cladding layer (see 404 in FIG. 4). For example, the additional cladding layer may include a relatively high index of refraction material such as a UV-cured polymer, a cross-linked polymer, a non-fluorinated hybrid sol-gel, or another conventional cladding material.

The bottom cladding layer 104 may be deposited as a low index of refraction sol-gel solution, as described above. For example, the bottom cladding layer may be deposited by spraying or spin-coating. Then, the bottom cladding may be dried and cured to form a solid film. For example, the wafer may be kept at about 100° C. to 200° C. for a period of time sufficient to provide the desired mechanical properties. For example, the temperature may be maintained for between 30 minutes and 10 hours. There has not been any detrimental effect found arising from 10 hour or longer dry and cure times.

In step 604, a waveguide structure 114 may be formed in the bottom clad 104. Generally, the waveguide structure 114 is formed parallel and below a top electrode. Etching may be performed by a number of methods. For example, plasma etching such as reactive ion etching or deep reactive ion etching may be used to form a trench waveguide 114, and may be advantageous for forming smooth and vertical trench sides.

Proceeding to step 606, a core material 102 including hyperpolarizable (aka non-linear) chromophores is deposited over the bottom cladding 104, for example by spin-coating or spraying. If the core material includes a polymer material such as an amorphous polycarbonate, the core 102 may be applied from solution during spinning or spraying, and then baked at elevated temperature to remove the solvent. Optionally, the core material may be reheated to reflow the top surface of the core 102 flat. If the core material includes a hybrid organic-inorganic material such as those described herein, the core may be dried and cured similar to the method described in conjunction with step 604 above. The electro-optic core 102 may optionally also include a low index of refraction hybrid organic-inorganic polymer.

Proceeding to step 608, a top cladding 106 is applied over the electro-optic material layer 102. Preparation, application, drying, and curing of the low index of refraction hybrid organic-inorganic material may be done as described above. Alternatively, the top cladding 106 may include another material such as a UV-cured polymer, UV-cured fluorinated sol-gel materials, a cross-linked polymer, a non-fluorinated sol-gel, or another conventional cladding material.

Proceeding to step 610, a poling electrode 116 may be formed over the upper cladding layer 106, and the electro-optic core 102 poled to align the chromophores as described above. The top electrode 112/116 shown in FIG. 1 may be configured as a modulation electrode and/or as a poling electrode. In some embodiments, such as that illustrated by FIG. 6, the poling electrode 116 may be removed after poling and a high speed electrode formed.

During step 610, the poling electrode 116 may be formed, for example by sputtering or solution plating over the top cladding 106. During poling, the core material 102 is brought up to near its glass transition temperature. Generally, it may be preferable for the temperature to be within ±10° C. of the glass transition temperature of the cross-linking core polymer. The elevated temperature makes it easier for the polar chromophore molecules to rotate to a parallel orientation responsive to the applied poling voltage.

Then, a poling circuit applies a poling voltage to the poling electrode and maintains the bottom electrode 110 at ground. The poling voltage may typically be up to about 900 to 1000 volts, depending on the device configuration. Typically, the poling voltage is maintained for about one to three minutes while the temperature is maintained, then the temperature is allowed to drop. The poling voltage is removed, typically shortly after the temperature reaches room temperature. The reduction in temperature causes the core polymer to drop below its glass transition temperature, which tends to immobilize the chromophores in the poled orientation.

According to alternative embodiments, the modulation electrode 112 may be used as a poling electrode 116. However, the process 601 shows a more conventional approach where separate poling 116 and modulation 112 electrodes are used.

Proceeding to step 612, the poling electrode 116 is stripped off the top of the top cladding 106. Optionally, an additional thickness of top cladding material may be deposited over the stripped top cladding 106. Then, a modulation electrode 112 is formed. The modulation electrode 112 is typically configured as a high speed (aka RF) strip electrode configured to conduct modulation signals at very high modulation bandwidths corresponding to optical signal transmission bandwidths. Typically, trace and electrode layouts take propagation delay and signal termination into account to maximize the transmission of in-phase, clean signals while minimizing reflections, impedence, and other deleterious effects.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A method for making a hybrid optical cladding, comprising:
providing a fluorinated sol-gel solution;
gelling the solution to produce a hybrid polymer; and
drying and curing the gel to form a hybrid optical cladding film.

2. The method of claim 1, wherein providing a fluorinated sol-gel solution includes combining:
a silica precursor,
an organically modified silica precursor including an organic cross-linking group; and
a modified silica precursor including a fluorinated organic group or fluorine.

3. The method of claim 2, wherein the silica precursor includes: 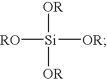
where —OR is a hydrolysable group.

4. The method of claim 3, wherein —OR is —OCH₃, —OCH₂—CH₃, or —O(CH₂)ₙ—CH₃; and n is two or more.

5. The method of claim 2, wherein the silica precursor includes at least one selected from the group consisting of tetraalkoxysilane, trialkoxyalkylsilane, tetraethoxysilane and tetramethoxysilane.

6. The method of claim 2, wherein the organically modified silica precursor including an organic cross-linking group includes: 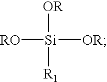
wherein R is an alkyl group; and
R₁ is a reactive cross-linker.

7. The method of claim 6, wherein R₁ includes an epoxy, glycidylpropylether, or an acrylate.

8. The method of claim 6, wherein R₁ includes: 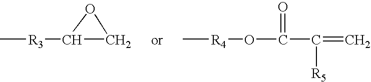
where R₃, R₄, and R₅ are alkyl or aromatic groups.

9. The method of claim 2, wherein the organically modified silica precursor including an organic cross-linking group includes at least one selected from the group consisting of glycidoxypropyltrimethoxysilane, glycidoxypropyltriethoxysilane, epoxytrimethoxysilane, epoxytriethoxysilane, acryltrimethoxysilane, and acryltriethoxysilane.

10. The method of claim 2, wherein the modified silica precursor including a fluorinated organic group or fluorine includes: 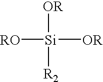
wherein R is an alkyl group; and
R₂ is a fluorinated organic group or fluorine.

11. The method of claim 10, wherein R₂ includes at least one selected from the group consisting of fluorine, a tridecafluoro-tetrahydrooctyl group, a tridecafluoro-tetrahydrooctyl group, a perfluorododecyl-1H,1H,2H,2H group, a perfluorotetradecyl-1H,1H,2H,2H group, and a pentafluorobenzyl group.

12. The method of claim 2, wherein the organically modified silica precursor including a fluorinated organic group or fluorine includes at least one selected from the group consisting of tridecafluoro-tetrahydrooctyltriethoxysilane, tridecafluoro-tetrahydrooctyltrimethoxysilane, perfluorododecyl-1H,1H,2H,2H-triethoxysilane, perfluorododecyl-1H,1H,2H,2H-trimethoxysilane, perfluorotetradecyl-1H,1H,2H,2H-triethoxysilane, perfluorotetradecyl-1H,1H,2H,2H-trimethoxysilane, pentafluorobenzyltriethoxysilane, pentafluorobenzyltrimethoxysilane, fluorotriethoxysilane, and fluorotrimethoxysilane.

13. The method of claim 1, wherein the hybrid polymer produced by gelling includes: 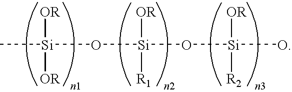
where R is an alkyl group, R₁ is a reactive cross-linker, R₂ is a fluorinated organic group or fluorine, and n1, n2, and n3 are between about 1 and 10.

14. The method of claim 13, wherein the hybrid polymer produced by gelling also includes Si—R₁—Si linkages.

15. The method of claim 13, wherein n2 is about equal to or less than n1 and n3.

16. The method of claim 12, wherein:
n1 is about 2;
n2 is about 1; and
n3 is about 1.

17. The method of claim 1, wherein the index of refraction of the hybrid optical cladding is less than 1.45 at about 1550 nanometers wavelength.

18. The method of claim 14, wherein the index of refraction of the hybrid optical cladding is between about 1.35 and 1.44 at about 1550 nanometers wavelength.

19. The method of claim 15, wherein the index of refraction of the hybrid optical cladding is between about 1.391 and 1.404 at 1550 nanometers wavelength.

20. A hybrid organic-inorganic optical cladding comprising the structure: 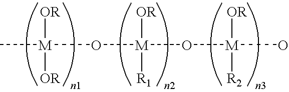
wherein:
M is Si, Ti, Al or Zr;
R is an alkyl group;
R₁ is a reactive cross-linker;
R₂ is a fluorinated organic group or fluorine; and
n1, n2, and n3 are between about 1 and 10.

21. The hybrid organic-inorganic optical cladding of claim 20, wherein M is silicon.

22. The hybrid organic-inorganic optical cladding of claim 20, wherein RO— is an ethoxy or methoxy group.

23. The hybrid organic-inorganic optical cladding of claim 20, wherein R₁ includes an epoxy, glycidylpropylether, or an acrylate.

24. The hybrid organic-inorganic optical cladding of claim 20, wherein R₂ includes at least one selected from the group consisting of fluorine, a tridecafluoro-tetrahydrooctyl group, a tridecafluoro-tetrahydrooctyl group, a perfluorododecyl-1H,1H,2H,2H group, a perfluorotetradecyl-1H,1H,2H,2H group, and a pentafluorobenzyl group.

25. The hybrid organic-inorganic optical cladding of claim 20, wherein:
n1 is about 2;
n2 is about 1; and
n3 is about 1.

26. The hybrid organic-inorganic optical cladding of claim 20, including M-R₁-M linkages.

27. The hybrid organic-inorganic optical cladding of claim 26, wherein the index of refraction is less than 1.45 at about 1550 nanometers wavelength.

28. The hybrid organic-inorganic optical cladding of claim 27, wherein the index of refraction is between about 1.35 and 1.44 at about 1550 nanometers wavelength.

29. The hybrid organic-inorganic optical cladding of claim 28, wherein the index of refraction is between about 1.391 and 1.404 at 1550 nanometers wavelength.

30. An electro-optic device, comprising:
an electro-optic core; and
at least one hybrid fluorinated sol-gel optical cladding adjacent to the electro-optic core.

31. The electro-optic device of claim 30, wherein the index of refraction of the hybrid fluorinated sol-gel optical cladding is less than 1.45 at 1550 nanometers wavelength.

32. The electro-optic device of claim 31, wherein the index of refraction of the hybrid fluorinated sol-gel optical cladding is between about 1.35 and 1.44 at 1550 nanometers wavelength.

33. The electro-optic device of claim 32, wherein the index of refraction of the hybrid fluorinated sol-gel optical cladding is between about 1.391 and 1.404 at 1550 nanometers wavelength.

34. The electro-optic device of claim 30, wherein the electro-optic core includes at least one hyperpolarizable organic chromophore and a cross-linked polymer.

35. The electro-optic device of claim 34, wherein the cross-linked polymer includes a hybrid fluorinated sol-gel polymer.

36. The electro-optic device of claim 34, wherein the at least one hybrid fluorinated sol-gel optical cladding includes the structure: 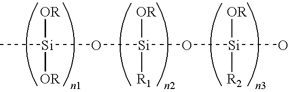
wherein:
R is an alkyl group;
R₁ is a reactive cross-linker;
R₂ is a fluorinated organic group or fluorine; and
n1, n2, and n3 are between about 1 and 10.

37. The electro-optic device of claim 36, wherein RO— is an ethoxy or methoxy group.

38. The electro-optic device of claim 36, wherein R₁ includes an epoxy, glycidylpropylether, or an acrylate.

39. The electro-optic device of claim 36, wherein R₂ includes at least one selected from the group consisting of fluorine, a tridecafluoro-tetrahydrooctyl group, a tridecafluoro-tetrahydrooctyl group, a perfluorododecyl-1H,1H,2H,2H group, a perfluorotetradecyl-1H,1H,2H,2H group, and a pentafluorobenzyl group.

40. The electro-optic device of claim 36, wherein:
n1 is about 2;
n2 is about 1; and
n3 is about 1.

41. The electro-optic device of claim 36, including Si—R₁—Si linkages.

42. The electro-optic device of claim 30, wherein:
the at least one hybrid fluorinated sol-gel optical cladding includes a bottom cladding and a top cladding disposed under and over the electro-optic core, respectively; and wherein;
the bottom clad is about 1-2.0 microns thick under a trench waveguide;
the electro-optic core is about 3 microns thick at the trench waveguide; and
the top clad is about 0.5 to 2.0 microns thick.

43. The electro-optic device of claim 30, wherein:
the at least one hybrid fluorinated sol-gel optical cladding includes a bottom cladding and a top cladding disposed under and over the electro-optic core, respectively; and wherein;
the bottom clad is about 2.0-3.0 microns thick;
the electro-optic core is about 3 microns thick; and
the top clad is about 0.5 to 2.0 microns thick.

44. A method of making an electro-optic device, comprising:
forming at least one fluorinated hybrid organic-inorganic optical film; and
forming at least one polymeric nonlinear optical film over or under the hybrid optical film.

45. The method of making an electro-optic device of claim 44, wherein forming at least one fluorinated hybrid organic-inorganic optical film includes combining:
a silica precursor,
an organically modified silica precursor including an organic cross-linking group; and
a modified silica precursor including a fluorinated organic group or fluorine.

46. The method of making an electro-optic device of claim 45, wherein the silica precursor includes: 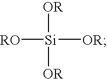
where —OR is a hydrolysable group.

47. The method of making an electro-optic device of claim 46, wherein R is —CH₃, —CH₂—CH₃, or —(CH₂)ₙ—CH₃; and
n is two or more.

48. The method of making an electro-optic device of claim 45, wherein the silica precursor includes at least one selected from the group consisting of tetraalkoxysilane, trialkoxyalkylsilane, tetraethoxysilane and tetramethoxysilane.

49. The method of making an electro-optic device of claim 45, wherein the organically modified silica precursor including an organic cross-linking group includes: 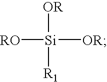
wherein R is an alkyl group; and
R₁ is a reactive cross-linker.

50. The method of making an electro-optic device of claim 49, wherein R₁ includes an epoxy, glycidylpropylether, or an acrylate.

51. The method of making an electro-optic device of claim 49, wherein R₁ includes: 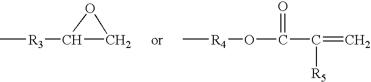
where R₃, R₄, and R₅ are alkyl or aromatic groups.

52. The method of making an electro-optic device of claim 45, wherein the organically modified silica precursor including an organic cross-linking group includes at least one selected from the group consisting of glycidoxypropyltrimethoxysilane, glycidoxypropyltriethoxysilane, epoxytrimethoxysilane, epoxytriethoxysilane, acryltrimethoxysilane, and acryltriethoxysilane.

53. The method of making an electro-optic device of claim 45, wherein the organically modified silica precursor including a fluorinated group or fluorine includes: 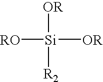
wherein R is an alkyl group; and
R₂ is a fluorinated organic group or fluorine.

54. The method of making an electro-optic device of claim 53, wherein R₂ includes at least one selected from the group consisting of fluorine, a tridecafluoro-tetrahydrooctyl group, a tridecafluoro-tetrahydrooctyl group, a perfluorododecyl-1H,1H,2H,2H group, a perfluorotetradecyl-1H,1H,2H,2H group, and a pentafluorobenzyl group.

55. The method of making an electro-optic device of claim 45, wherein the organically modified silica precursor including a fluorinated organic group or fluorine includes at least one selected from the group consisting of tridecafluoro-tetrahydrooctyltriethoxysilane, tridecafluoro-tetrahydrooctyltrimethoxysilane, perfluorododecyl-1H,1H,2H,2H-triethoxysilane, perfluorododecyl-1H,1H,2H,2H-trimethoxysilane, perfluorotetradecyl-1H,1H,2H,2H-triethoxysilane, perfluorotetradecyl-1H,1H,2H,2H-trimethoxysilane, pentafluorobenzyltriethoxysilane, pentafluorobenzyltrimethoxysilane, fluorotriethoxysilane, and fluorotrimethoxysilane.

56. The method of making an electro-optic device of claim 44, forming at least one fluorinated hybrid organic-inorganic optical film includes gelling a sol-gel solution; and
wherein a hybrid organic-inorganic polymer produced by gelling includes: 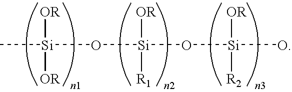
where R is an alkyl group, R₁ is a reactive cross-linker, R₂ is a fluorinated organic group or fluorine, and n1, n2, and n3 are between about 1 and 10.

57. The method of making an electro-optic device of claim 56, wherein the hybrid polymer produced by gelling also includes Si—R₁—Si linkages.

58. The method of making an electro-optic device of claim 56, wherein n2 is about equal to or less than n1 and n3.

59. The method of making an electro-optic device of claim 56, wherein:
n1 is about 2;
n2 is about 1; and
n3 is about 1.

60. The method of making an electro-optic device of claim 44, wherein the index of refraction of the at least one fluorinated hybrid organic-inorganic optical film is less than 1.45 at about 1550 nanometers wavelength.

61. The method of making an electro-optic device of claim 60, wherein the index of refraction of the at least one fluorinated hybrid organic-inorganic optical film is between about 1.35 and 1.44 at about 1550 nanometers wavelength.

62. The method of making an electro-optic device of claim 61, wherein the index of refraction of the at least one fluorinated hybrid organic-inorganic optical film is between about 1.35 and 1.44 at 1550 nanometers wavelength.

63. The method of making an electro-optic device of claim 44, forming at least one fluorinated hybrid organic-inorganic optical film is doped with about 3% or less lithium perchlorate.
